(19) United States
(12) Patent Application Publication
(10) Pub. No.: US 2025/0129495 A1
(43) Pub. Date: Apr. 24, 2025

(54) METHOD FOR THE ELECTROCHEMICAL SYNTHESIS OF AMMONIA AND APPARATUS FOR CARRYING OUT THE METHOD

(71) Applicant: GENCELL LTD., Petah Tikva (IL)

(72) Inventors: Gennadi FINKELSHTAIN, Modiin (IL); Nino BORCHTCHOUKOVA, Modiin (IL); Alexander V. SHIROKOV, Ashkelon (IL); Joseph Alexander ENGLANDER, Petah-Tikva (IL); Ronit SHARABI, Kfar Yona (IL); Maxim ZABILSKIY, Stein (CH); Tsepin TSAI, Taipei (TW)

(21) Appl. No.: 18/692,901

(22) PCT Filed: Sep. 23, 2022
(86) PCT No.: PCT/US2022/076898

§ 371 Date: Mar. 18, 2024

Related U.S. Application Data
(60) Provisional application No. 63/261,615, filed on Sep. 24, 2021.

(51) Int. Cl. C25B 11/032; C25B 1/27; C25B 9/05; C25B 11/061; C25B 11/081; C25B 15/021

(52) U.S. Cl. CPC C25B 11/032; C25B 1/27; C25B 9/05; C25B 11/061; C25B 11/081; C25B 15/021

(57) ABSTRACT

A method for the electrochemical synthesis of ammonia (NH₃) comprises contacting a nitrogen-containing gas with the cathode of an electrochemical cell comprising a cathode, an anode, an alkaline aqueous electrolyte, and preferably an anion exchange membrane. The cathode is a porous gas diffusion electrode which comprises an active layer comprising a material which is capable of catalyzing the electrochemical reduction of nitrogen and is in contact with the electrolyte, a layer of electroconductive material supporting the active layer, and a porous polymer film on the side of the active layer which does not come into contact with the electrolyte and comes into direct contact with the nitrogen-containing gas. A potential over the electrochemical cell is applied to effect the electrochemical synthesis of ammonia from nitrogen and water. The method can be used to synthesize ammonia without using molecular hydrogen.

### BACKGROUND OF THE INVENTION

### 1. Field of the Invention

The present invention relates to a method for the electrochemical synthesis of ammonia from nitrogen and water and an apparatus and gas diffusion electrode for use in the method.

### 2. Discussion of Background Information

Ammonia (NH₃) is a chemical used extensively in industry and as agricultural fertilizer, but it can also be utilized as a renewable energy storage intermediate. Currently production of ammonia is achieved by the energetically demanding Haber-Bosch process, which is associated with low efficiencies. The century-old Haber-Bosch process for ammonia synthesis requires harsh operating conditions including high temperatures (400-500° C.) and high pressures (150-300 atm) using heterogeneous iron-based catalysts. The worldwide production of ammonia in 2019 was 235 million tons, which accounts for 1-2% of the world's energy supply and causes about 1% of the total global energy-related CO₂ emissions. An emerging alternative to the Haber-Bosch process is the electrochemical synthesis of ammonia through the nitrogen reduction reaction (NRR). In the electrochemical ammonia synthesis, ammonia is formed by applying a potential over an electrochemical cell with a catalyst. Sec, for example, US 2016/0083853 A1, the entire disclosure of which is incorporated by reference herein. The electrocatalytic reduction process is considered to be an environmentally friendly approach for NH₃ production; in fact, it can be performed at mild conditions, such as room temperature and atmospheric pressure, and it can also be powered by renewable energy.

Ammonia consists of 17.6 wt % hydrogen, which makes ammonia an indirect hydrogen storage compound. Ammonia's energy density is 4.32 kWh/liter, which is similar to that of methanol (CH₃OH), and approximately double that of liquid hydrogen. Liquefying hydrogen is more energy demanding when compared to ammonia since ammonia liquefies at −33.4° C. at atmospheric pressure, whereas hydrogen must be liquefied by chilling to temperatures lower than −253° C. Another drawback of using hydrogen as an energy carrier is the difficulty of transporting and storing it without dissipation, and thereby being unavailable for its intended end use. In addition, unlike hydrogen, ammonia is not typically explosive. Taking into account the above-mentioned factors, ammonia is considered a preferable energy storage intermediate to hydrogen.

Several research efforts have been aimed at developing an electrochemical ammonia synthesis based on different electrolytes. Ranging from solid state oxide to molten salt, most of these efforts are focusing on medium to high temperature systems. While at higher temperatures the kinetics of the ammonia synthesis are better, the thermodynamic efficiency at higher temperatures is lower. The parasitic energy loss in the balance of plant to maintain the desired operating temperature represents an additional problem. Moreover, due to the high temperatures involved, the electrochemical reactor must be constructed with relatively expensive materials. In addition, the overall system seems to exhibit poor stability in long-term operation.

Ammonia synthesis or nitrogen fixation by electrochemical means usually is done by providing a electrochemical cell with a nitrogen source, preferably pure N₂ from purified air, and protons (H⁺), e.g., from the anodic oxidation of pure hydrogen. Due to the presence of water in the system mainly from supplied electrolyte, side reactions such as water electrolysis can occur and compete with both anodic and cathodic reactions. On the anode H₂ or OH⁻ are oxidized with the use of an appropriate catalyst that can assist in directing the reaction to the desired products.

In view of the foregoing, it would be advantageous to have available a system and method for the electrochemical synthesis of ammonia which is capable of synthesizing ammonia directly from water and nitrogen by using a low temperature electrolyte system and further using water as the source of hydrogen through in-situ water splitting during the electrochemical synthesis of ammonia.

### SUMMARY OF THE INVENTION

The present invention provides a method for the electrochemical synthesis of ammonia. The method comprises contacting a nitrogen-containing gas with the cathode of an electrochemical cell which comprises the cathode, an anode and an alkaline aqueous electrolyte. The cathode is a porous gas diffusion electrode which comprises (i) an active layer comprising a material which is capable of catalyzing the electrochemical reduction of nitrogen (N₂) and is in direct contact with the electrolyte, (ii) a layer of electroconductive material supporting the active layer and (iii) a porous polymer film on the side of the active layer which does not come into direct contact with the electrolyte but comes into direct contact with the nitrogen-containing gas. The anode is made of an electroconductive material which is inert with respect to the electrolyte. The method further comprises applying a potential over the electrochemical cell to effect the electrochemical synthesis of ammonia from nitrogen and water.

In one aspect of the method, the method may be carried out at a temperature of from about 20° C. to about 200° C. and/or at a pressure from about atmospheric pressure to about 10 atm, for example, at ambient (room) temperature and atmospheric pressure.

In another aspect, the method may be carried out continuously or batchwise.

In yet another aspect of the method, the nitrogen-containing gas may be substantially pure nitrogen.

In a still further aspect of the method, a stream of the nitrogen-containing gas may be caused to contact the porous polymer film of the gas diffusion electrode.

In another aspect, no molecular hydrogen (H₂) is employed during the electrochemical synthesis of ammonia (i.e., no molecular hydrogen which is not produced in situ during an electrochemical reaction).

In another aspect, the alkaline aqueous electrolyte may comprise a hydroxide of an alkali metal such as Na or K and/or a hydroxide of an alkaline earth metal such as Mg or Ca.

In another aspect of the method, a constant potential or a constant current may be employed.

The present invention also provides an apparatus for carrying out the method set forth above (including one or more of the various aspects thereof). The apparatus comprises an electrochemical cell which comprises a cathode, an anode and an alkaline aqueous electrolyte. The cathode is a porous gas diffusion electrode which comprises (i) an active layer comprising a material which is capable of catalyzing the electrochemical reduction of nitrogen (N₂) and is in direct contact with the electrolyte, (ii) a layer of electroconductive material supporting the active layer and (iii) a porous polymer film on the side of the active layer which is not in direct contact with the electrolyte. The anode is made of an electroconductive material which is inert with respect to the electrolyte.

In one aspect of the apparatus, the active layer may further comprise a binder material such as, e.g., a hydrophobic polymer.

In another aspect of the apparatus, the material which is capable of catalyzing the electrochemical reduction of nitrogen may comprise one or more of Pd, Pt, Au, Ir, Ru, Rh, Ni, Co, Mo, Cr, Ti, Zr, Hf, V, Nb, Ta, Fe and Mn.

In yet another aspect of the apparatus, the layer of electroconductive material of the cathode may comprise a metal mesh such as, e.g., a nickel mesh, and/or may be embedded in the active layer.

In another aspect of the apparatus, the porous polymer film may comprise or consist of a hydrophobic polymer such as a fluorinated polymer.

In another aspect of the apparatus, the anode may be present in the form of a metal mesh such as, e.g., a nickel mesh.

In a still further aspect, the apparatus may further comprise a containment which is directly adjacent to and in direct contact with the cathode side of the electrochemical cell and comprises an inlet and an outlet for gas, through which a stream of nitrogen-containing gas which is to come into contact with the polymer film of the cathode can be passed.

In another aspect of the apparatus, the electrochemical cell further comprises a separator such as, e.g., an anion exchange membrane which separates the cathode side of the electrolyte from the anode side of the electrolyte.

In another aspect, the apparatus may further comprise a potentiostat and/or a galvanostat.

The present invention also provides a porous gas diffusion electrode which is suitable for use in the apparatus set forth above (including one or more of the various aspects thereof). The electrode comprises (i) an active layer comprising a material which is capable of catalyzing the electrochemical reduction of nitrogen (N₂) in the presence of an alkaline aqueous electrolyte, (ii) a layer of electroconductive material supporting the active layer and (iii) a porous polymer film on the side of the active layer which is opposite to the side of the active layer which is to come into direct contact with the electrolyte.

In one aspect of the electrode, the active layer may further comprise a binder such as a hydrophobic polymer (e.g., a fluorinated polymer).

In another aspect of the electrode, the polymeric film may comprise or consist of a hydrophobic polymer (e.g., a fluorinated polymer such as tetrafluoroethylene). This polymer may be the same as the polymer used as binder in the active layer.

In yet another aspect of the electrode, the electrode may have an average pore size of from about 7 nm to about 9 nm and/or the polymer film may have a thickness of not higher than about 0.75 mm and/or the electrode has a total thickness of not more than about 0.85 mm.

### BRIEF DESCRIPTION OF THE DRAWINGS

The present invention is further described in the detailed description which follows, in reference to the accompanying drawings by way of non-limiting examples of exemplary embodiments of the present invention. In the drawings:

FIG. 1 schematically shows an electrolytic reactor which was used in the experiments described below;

FIG. 2 schematically shows a gas diffusion electrode for use in the apparatus of the invention;

FIG. 3 is a graph of current vs. voltage obtained by cyclic voltammetry with a gas diffusion electrode of the invention which comprises a Pt—Pd nitrogen reduction catalyst;

FIG. 4 is a graph of concentration of ammonia vs. sampling time obtained in the experiments described below; and

FIG. 5 is a graph of concentration of ammonia vs. sampling time obtained in the control experiment described below.

### DETAILED DESCRIPTION OF EMBODIMENTS OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

As used herein, the singular forms “a,” “an,” and “the” include the plural reference unless the context clearly dictates otherwise. For example, reference to “a gas” would also mean that mixtures of two or more gases can be present unless specifically excluded.

Except where otherwise indicated, all numbers expressing quantities of ingredients, reaction conditions, etc. used in the instant specification and appended claims are to be understood as being modified in all instances by the term “about.” Accordingly, unless indicated to the contrary, the numerical parameters set forth in the present specification and the appended claims are approximations that may vary depending upon the desired properties sought to be obtained by the present invention. At the very least, each numerical parameter should be construed in light of the number of significant digits and ordinary rounding conventions.

Additionally, the disclosure of numerical ranges within this specification is considered to be a disclosure of all numerical values and ranges within that range. For example, if a range is from 1 to 50, it is deemed to include, for example, 1, 7, 34, 46.1, 23.7, or any other value or range within the range.

As stated above, the method of the present invention comprises contacting a nitrogen-containing gas (e.g., pure nitrogen, but also air from which gases such as CO₂ which may poison the nitrogen reduction catalyst in the cathode have been removed) with the cathode of an electrochemical cell which comprises the cathode, an anode and an alkaline aqueous electrolyte. The cathode is a porous gas diffusion electrode which comprises (i) an active layer comprising a material which is capable of catalyzing the electrochemical reduction of nitrogen (N₂) (herein sometimes simply referred to as “reduction catalyst” or “catalytic material”) and is in direct contact with the electrolyte, (ii) a layer of electroconductive material supporting (being a substrate for) the active layer and (iii) a porous polymer film on the side of the active layer which does not come into direct contact with the electrolyte but comes into direct contact with the nitrogen-containing gas. The anode is made of an electroconductive material which is inert with respect to the electrolyte (e.g., the same electroconductive material which is used as the electroconductive material (ii)). The method further comprises applying a potential over the electrochemical cell to effect the electrochemical synthesis of ammonia from nitrogen and water. In a preferred embodiment, the method is carried out without using molecular hydrogen (other than any molecular hydrogen which may be formed in situ during the electrochemical reaction). The ability to produce ammonia without the use of molecular hydrogen is a major (and unexpected) advantage of the method. It further is preferred to use an anion exchange membrane to separate the cathode side of the electrolyte from the anode side of the electrolyte.

The method may be carried out at a temperature of from about 20° C. to about 200° C. and/or at a pressure from about atmospheric pressure to about 10 atm. For example, it may be (and preferably is) carried out at atmospheric pressure and at ambient (room) temperature (e.g., from about 20° C. to about 30° C.).

The method may further be carried out continuously or batch-wise, a continuous or semi-continuous operation being preferred.

While the nitrogen-containing gas employed in the method may contain other gases in addition to nitrogen (e.g., oxygen, helium, argon and mixtures thereof), it is usually preferred for the nitrogen-containing gas to be substantially pure nitrogen, such as nitrogen having a purity of at least 95%, at least 98%, at least 99%, at least 99.5% or at least 99.9% (all by volume).

The alkaline aqueous electrolyte of the electrochemical cell may be a liquid and/or a gel electrolyte and will often comprise a hydroxide of an alkali metal such as Na and/or K (in particular, KOH) and/or a hydroxide of an alkaline earth metal such as Mg and/or Ca. The concentration of the hydroxide may, for example, range from about 0.5M to about 9M, e.g., from about 1M to about 5M, and the pH of the electrolyte will often be at least about 8, e.g., at least about 9, at least about 10, or at least about 11.

The apparatus for carrying out the method of the present invention comprises an electrochemical cell which comprises a cathode, an anode and an alkaline aqueous electrolyte. The cathode is a porous gas diffusion electrode which comprises (i) an active layer comprising a material which is capable of catalyzing the electrochemical reduction of nitrogen (N₂) and is in direct contact with the electrolyte, (ii) a layer of electroconductive material supporting (being a substrate for) the active layer and (iii) a porous polymer film on the side of the active layer which is not in direct contact with the electrolyte. The anode is made of an electroconductive material which is inert with respect to the electrolyte.

The active layer (i) may further comprise (and preferably comprises) a binder material such as, e.g., a hydrophobic polymer. Generally, the active layer of a gas diffusion electrode is designed to optimize the contact between reactant gas, electrolyte and catalyst in a so-called three-phase boundary (solid-liquid-gas in the case of liquid electrolyte) to maximize the reaction rate. Catalysts are incorporated into active layer structures to increase the rates of the desired reactions. Catalysts are often precious metals or alloys thereof in a very high surface area form, dispersed and supported on high surface area electrically conducting porous carbon black or graphite. The catalyst component may also comprise a non-precious metal, such as one or more of the transition metals. Active layers often also comprise non-catalytic components in addition to the catalyst material, usually polymeric materials which act as binders to hold the layer together and may also have the additional function of adjusting the hydrophobic/hydrophilic balance of the final structure. The hydrophobic binder, frequently polytetrafluoroethylene (PTFE), commercially known as Teflon®, is employed mainly in two forms, i.e., as a dry powder or as a suspension. One of the best ways is the preparation of a material called teflonized carbon black. This is done by mixing carbon black and a PTFE suspension. As result, a highly hydrophobic material with a high rate of gas diffusion is obtained. This material is described in, for example, U.S. Pat. Nos. 3,537,906 and 4,031,033, the entire disclosures of which are incorporated by reference herein.

The polymeric binder for use in the active layer (i) may be hydrophobic and may, for example, be selected from hydrophobic polymers such as fluorinated polymers (e.g., PTFE, polyhexafluoropropylene, polychlorofluoroethylene, polyvinylidene fluoride, and fluorinated ethylene-propylene copolymers), polyvinyl chloride, polyethylene, polypropylene, ethylene-propylene copolymers, polyisobutenes, and combinations of two or more thereof. A preferred polymeric binder for use in the active layer is PTFE. Depending on the hydrophobicity of the reduction catalyst employed, the polymeric binder for the active layer may also be a mixture of one or more hydrophobic polymers and one or more hydrophilic polymers to adjust the hydrophilic/hydrophobic balance of the active layer to an appropriate value (to provide a sufficiently stable three-phase boundary). Non-limiting examples of suitable hydrophilic polymers for this purpose include polysulfones, perfluorosulfonate ionomers, and epoxy resins.

The binders for the active layer (i) may be selected for use in a combination that assures the proper hydrophobic/hydrophilic balance of the electrode, which provides the optimum ionic conduction pathways in the electrode. An additional advantage of this method is that the incorporation of polymeric materials into the structure can be carefully controlled. This provides the ability to tailor the hydrophobic/hydrophilic nature of the matrix to give improved performance characteristics.

The material which is capable of catalyzing the electrochemical reduction of nitrogen may comprise, for example, one or more of Pd, Pt, Au, Ir, Ru, Rh, Ni, Co, Mo, Cr, Ti, Zr, Hf, V. Nb. Ta, Fe and Mn, as such or in the form of alloys and compounds thereof (e.g., oxides). A non-limiting list of suitable reduction catalysts includes one or more of Pd, Ni, Au, Pd—Pt, Pd—Ni, Au—Ni, Au—Pd, Au—Ni—Pd, MoS—FeMoS, NiO—Cr₂O₃, CoO—Cr₂O₃, NiO—MoO₃, CoO—MoO₃, and CoO—Fe₂O₃.

The layer of electroconductive material (ii) (electrically conductive substrate) must be capable of withstanding the alkaline conditions provided by the electrolyte and may be selected from, e.g., the electrically conductive support structures that are known for this purpose. The material may, for example, be selected from, but not limited to, an electrically conductive mesh, a grid, a metal foam, an expanded metal, and any combinations thereof. A preferred electrically conductive substrate for use in the gas diffusion electrode of the present invention is an electrically conductive metal mesh (e.g., a nickel mesh). The electrically conductive substrate may be made of any electrically conductive material and is preferably made of a metallic material such as a pure metal or a metal alloy. Other suitable electroconductive materials (ii) include, for example, carbon fibers, carbon paper, glassy carbon, carbon nanofibers, and carbon nanotubes. The electroconductive material will often be embedded in the active layer.

The porous polymer film (iii) of the gas diffusion electrode of the present invention may comprise or consist of a hydrophobic polymer which may, for example, be selected from fluorinated polymers (e.g., PTFE, polyhexafluoropropylene, polychlorofluoroethylene, polyvinylidene fluoride, and fluorinated ethylene-propylene copolymers), polyvinyl chloride, polyethylene, polypropylene, ethylene-propylene copolymers, polyisobutenes, and combinations of two or more thereof. A preferred polymeric binder for use in the polymer film (iii) is PTFE.

It is advantageous to use the same hydrophobic polymer for the production of the porous polymer film (iii) and the active layer (i) of the gas diffusion electrode of the present invention. This ensures a particularly good adhesion between porous polymer film (iii) and active layer (i).

The anode of the electrochemical cell may be the same or similar to the layer of electroconductive material (ii) which is used in the cathode of the electrochemical cell. Examples thereof are the same as those set forth above for the material (ii). For example, the anode may be present in the form of a metal mesh such as, e.g., a nickel mesh.

The apparatus of the present invention may further comprise a containment which is directly adjacent to and in direct contact with the cathode side of the electrochemical cell and comprises an inlet and an outlet for gas, through which a stream of nitrogen-containing gas which is to come into contact with the polymer film of the cathode can be passed.

The electrochemical cell of the apparatus of the present invention will normally comprise a separator such as, e.g., an anion exchange membrane or a thin polymeric film which permits the passage of ions and separates the cathode side of the electrolyte from the anode side of the electrolyte. An anion exchange membrane is a preferred separator for use in the apparatus.

The porous gas diffusion electrode which is suitable for use in the apparatus of the present invention comprises (i) an active layer comprising a material which is capable of catalyzing the electrochemical reduction of nitrogen (N₂) in the presence of an alkaline aqueous electrolyte, (ii) a layer of electroconductive material supporting (being a substrate for) the active layer and (iii) a porous polymer film on the side of the active layer which is opposite to the side of the active layer which is to come into direct contact with the electrolyte. Details of the electrode have been discussed above.

In exemplary embodiments, the gas diffusion electrode of the present invention, which will usually be present in the form of a sheet, may have an average pore size of from about 7 nm to about 9 nm. The polymer film (iii) may have a thickness of, for example, not higher than about 0.75 mm, e.g., from about 0.3 mm to about 0.7 mm. The total thickness of the gas diffusion electrode of the present invention preferably is not higher than about 0.85 mm, and may be as low as about 0.5 mm.

### Experimental Section

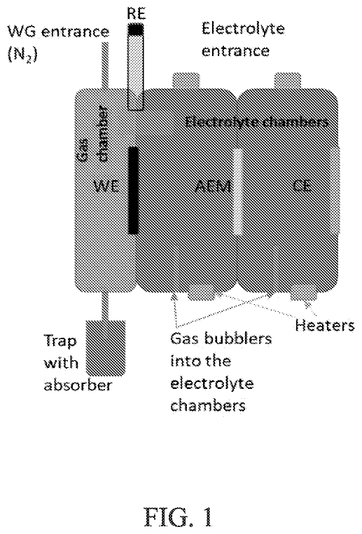

The electrochemical reactor used in the experiments described below had an effective electrode area of 10 cm² and is shown schematically in FIG. 1, in which the following abbreviations are used:
WE=Working Electrode (cathode)
CE=Counter Electrode (anode)
RE=Reference Electrode
WG=Working Gas
AEM=Anion Exchange Membrane (separator).

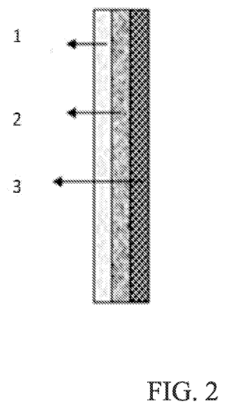

The general structure of the cathode used is shown in FIG. 2, wherein 1 is a PTFE film, 2 is the active layer and 3 is a nickel mesh, which is (partially) embedded in the active layer 2.

Cathode preparation: 25 g of catalyst (Pd—Pt deposited on carbon) was mixed with PTFE at a weight ratio 80/20. Mixing was carried out at room temperature with a blender for about 15-30 min. The resultant mixture of catalyst and PTFE was placed into a rolling device to obtain a catalyst layer thin film. The produced catalyst layer was embedded in a nickel mesh. Then a porous PTFE film was applied on the surface of the catalyst layer which is opposite to the side of the nickel mesh, yielding the electrode.

The cathode electrolyte chamber was separated from the anode electrolyte chamber by a separator. The separator used was purchased from Fuma-Tech and composed of a long side-chain perfluorosulfonic acid polymer (Fumion® F).

Two different electrolytic cells with two electrolyte chambers were used. One cell had a total volume of 660 ml (330 ml per chamber) and the other one had a total volume of 360 ml.

The process was carried out at room temperature and atmospheric pressure.

A reference electrode of mercury/mercury oxide—Hg/HgO (hereafter “MMO”) was filled with 6.6M KOH, connected to the cell by a salt bridge. Pure nitrogen gas (99.99%) was streamed to the electrolyte solution and to the cathode gas chamber. Nitrogen or argon were streamed to the anode electrolyte camber to remove dissolved gases in the solution.

The outlets of the cathode electrolyte and gas chambers were connected to a trap containing a diluted solution of sulfuric acid (H₂SO₄) for retention of synthesized ammonia as ammonium salt.

An electric device (potentiostat/galvanostat) was connected to the reactor to apply a constant potential or constant current, respectively, to the system.

The procedure of operating the cell for synthesizing ammonia was as follows:

Once the cell was assembled and all electrodes were in place the cell was loaded with fresh electrolyte (aqueous KOH, 1M, 5.4% w/w).

Fresh sulfuric acid solution was placed in the trap and connected to the cathode gas outlet.

N₂ gas was bubbled into the cathode electrolyte chamber in order to purge dissolved oxygen. The same was done in the case of the anode electrolyte chamber with argon or N₂.

The electrodes were connected to a potentiostat/galvanostat and the OCV (Open Circuit Voltage) of the system was measured. Chrono-amperometry was applied at various potentials from −0.9V to −1.1V vs. MMO for a set period of time while gases continued to stream into the chambers and passed through the acid traps.

The solution in the acid trap was sampled periodically and tested for the presence of ammonia. Currents and electrode potentials (cathode and anode) were recorded and observed throughout the operation of the cell.

The produced ammonia concentration was determined by colorimetric methods using a UV VIS spectrometer. Two identification and quantification methods were used: one which utilizes Nessler's reagent-potassium tetraiodomercurate (II) and another one which is based on the Berthelot reaction with salicylic acid as an indophenol derivative. The initial step in the quantification of ammonia was to establish a calibration curve for both Nessler's reagent and Berthelot reaction with known concentrations of ammonium chloride as a precursor of ammonia.

Solutions of ammonium chloride with known concentrations were prepared from a 1000 ppm stock solution. NH₄Cl samples with concentrations from 1 ppm to 6 ppm were prepared with Nessler's reagent and with Berthelot reaction and resulting absorbance readings were plotted to form a calibration curve.

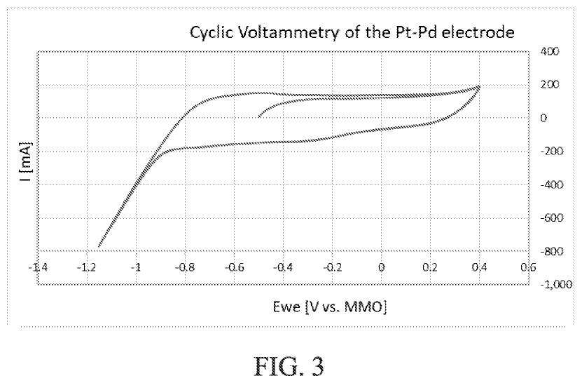

The constant potential, to be applied to a specific electrode, was determined by testing the electrode in cyclic voltammetry to determine when the reduction of water begins, a process needed for the ammonia synthesis. The results are shown in FIG. 3.

### Results:

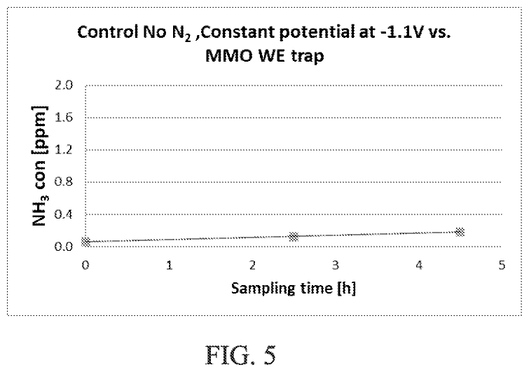

Under the conditions described above a concentration of 2.8 mg/L ammonia was detected after a 14-hour operation. This concentration was observed in the working electrode (cathode) trap. No ammonia was detected in the counter electrode trap used as a control. Control experiments such as replacing the nitrogen gas flow with argon (see FIG. 5) or removing the applied potential, all confirmed that the observed ammonia was the product of an electrochemical synthesis.

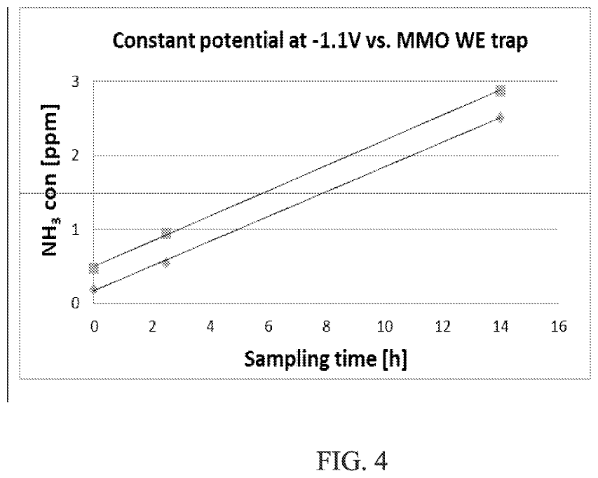

FIG. 4 shows the concentration of ammonia as a function of the sampling time at a constant potential of −1.1V vs. the MMO working electrode trap. The total ammonia concentration measured is the sum of detected ammonia in the cathode acid trap and in the cathode electrolyte solution. The upper curve in FIG. 4 shows the combined ammonia concentrations, whereas the lower curve shows the ammonia concentration in the working electrode trap as set forth in part in the table below. FIG. 5 shows the results of a control experiment without the use of N₂.

| | WE trap | Electrolyte | Total |
|---|---|---|---|
| Time └h┘ | Con └ppm┘ | Con └ppm┘ | Concentration |
| 0 | 0.198 | 0.282 | 0.480 |
| 2.5 | 0.548 | 0.401 | 0.948 |
| 14 | 2.517 | 0.363 | 2.880 |

Obtained ammonia quantities were calculated from the corresponding ppm concentrations measured in the samples of the acid trap and electrolyte, taking into account the volumes for the total solutions in the acid trap and the electrolyte. The total obtained ammonia quantities were 0.35 mg ammonia, corresponding to 35 μg of ammonia per cm² of electrode surface, as well as 2.5 μg of ammonia per hour and cm² of electrode surface.

1.-33. (canceled)

34. A method for the electrochemical synthesis of ammonia (NH₃), wherein the method comprises contacting a nitrogen-containing gas with a cathode of an electrochemical cell which comprises the cathode, an anode and an alkaline aqueous electrolyte, the cathode being a porous gas diffusion electrode which comprises (i) an active layer comprising a material which is capable of catalyzing an electrochemical reduction of nitrogen (N₂) and is in direct contact with the electrolyte, (ii) a layer of electroconductive material supporting the active layer and (iii) a porous polymer film on a side of the active layer which does not come into direct contact with the electrolyte and comes into direct contact with the nitrogen-containing gas, and the anode being made of an electroconductive material which is inert with respect to the electrolyte, and applying a potential over the electrochemical cell to effect the electrochemical synthesis of ammonia from nitrogen and water.

35. The method of claim 34, wherein the method is carried out at a temperature of from about 20° C. to about 200° C. and/or at a pressure from about atmospheric pressure to about 10 atm.

36. The method of claim 34, wherein the method is carried out continuously.

37. The method of claim 34, wherein the method is carried out batchwise.

38. The method of claim 34, wherein the nitrogen-containing gas is substantially pure nitrogen.

39. The method of claim 34, wherein a stream of the nitrogen-containing gas is caused to contact the porous polymer film of the gas diffusion electrode.

40. The method of claim 34, wherein no molecular hydrogen (H₂) is employed.

41. The method of claim 34, wherein the aqueous electrolyte comprises a hydroxide of an alkali metal and/or an alkaline earth metal.

42. The method of claim 34, wherein a constant potential is employed.

43. The method of claim 34, wherein a constant current is employed.

44. The method of claim 34, wherein the material which is capable of catalyzing the electrochemical reduction of nitrogen comprises one or more of Pd, Pt, Au, Ir, Ru, Rh, Ni, Co, Mo, Cr, Ti, Zr, Hf, V, Nb, Ta, and Mn.

45. An apparatus for carrying out the method of claim 34, wherein the apparatus comprises an electrochemical cell which comprises a cathode, an anode and an alkaline aqueous electrolyte, the cathode being a porous gas diffusion electrode which comprises (i) an active layer comprising a material which is capable of catalyzing an electrochemical reduction of nitrogen (N₂) and is in direct contact with the electrolyte, (ii) a layer of electroconductive material supporting the active layer and (iii) a porous polymer film on a side of the active layer which is not in direct contact with the electrolyte, the anode being made of an electroconductive material which is inert with respect to the electrolyte.

46. The apparatus of claim 45, wherein the active layer further comprises a binder material which comprises a hydrophobic polymer.

47. The apparatus of claim 45, wherein the material which is capable of catalyzing the electrochemical reduction of nitrogen comprises one or more of Pd, Pt, Au, Ir, Ru, Rh, Ni, Co, Mo, Cr, Ti, Zr, Hf, V, Nb, Ta, and Mn.

48. The apparatus of claim 45, wherein the layer of electroconductive material of the cathode comprises a metal mesh.

49. The apparatus of claim 45, wherein the apparatus further comprises a containment which is adjacent to a cathode side of the electrochemical cell and comprises an inlet and an outlet for gas and through which a stream of nitrogen-containing gas which is to come into contact with the polymer film of the cathode can be passed.

50. A porous gas diffusion electrode suitable for use in the apparatus of claim 45, wherein the electrode comprises (i) an active layer comprising a material which is capable of catalyzing an electrochemical reduction of nitrogen (N₂) in the presence of an aqueous alkaline electrolyte, (ii) a layer of electroconductive material supporting the active layer and (iii) a porous polymer film on a side of the active layer which is opposite to the side of the active layer which is to come into contact with the electrolyte.

51. The electrode of claim 50, wherein the electrode has an average pore size of from about 7 nm to about 9 nm.

52. The electrode of claim 50, wherein the polymer film has a thickness of not higher than about 0.75 mm and the electrode has a total thickness of not more than about 0.85 mm.

53. A method for the electrochemical synthesis of ammonia (NH₃), wherein the method is carried out without using molecular hydrogen (H₂) and comprises contacting a nitrogen-containing gas with a cathode of an electrochemical cell which comprises the cathode, an anode, an alkaline aqueous electrolyte, and an anion exchange membrane for separating a cathode side of the electrolyte from an anode side of the electrolyte, the cathode being a porous gas diffusion electrode which comprises (i) an active layer comprising a material which is capable of catalyzing an electrochemical reduction of nitrogen (N₂) and is in direct contact with the electrolyte, (ii) a layer of electroconductive material supporting the active layer and (iii) a porous polymer film on a side of the active layer which does not come into direct contact with the electrolyte and comes into direct contact with the nitrogen-containing gas, and the anode being made of an electroconductive material which is inert with respect to the electrolyte, and applying a potential over the electrochemical cell to effect the electrochemical synthesis of ammonia from nitrogen and water.
